(19) United States
(12) Patent Application Publication
(10) Pub. No.: US 2026/0129359 A1
(43) Pub. Date: May 7, 2026

(54) CORE ASSEMBLIES FOR WATERPROOF EARPHONES AND WATERPROOF EARPHONES

(71) Applicant: SHENZHEN SHOKZ CO., LTD., Shenzhen (CN)

(72) Inventors: Hao KE, Shenzhen (CN); Yongjian LI, Shenzhen (CN)

(73) Assignee: SHENZHEN SHOKZ CO., LTD., Shenzhen (CN)

(21) Appl. No.: 19/437,290

(22) Filed: Dec. 30, 2025

Related U.S. Application Data
(63) Continuation of application No. PCT/CN2023/143663, filed on Dec. 29, 2023.

(51) Int. Cl. H04R 1/44; H04R 1/02; H04R 1/10

(52) U.S. Cl. CPC H04R 1/44; H04R 1/021; H04R 1/105; H04R 1/1066; H04R 2460/13

(57) ABSTRACT

The present disclosure relates to a core assembly of a waterproof earphone and the waterproof earphone, and relates to the field of waterproof earphones. The core assembly of the waterproof earphone includes a housing and a core module. The housing includes an upper housing and a lower housing. The upper housing and the lower housing are connected to form an accommodating cavity. The core module includes a core bracket and a core. The core is mounted on the core bracket. The core bracket is mounted in the accommodating cavity. A gap is provided at a connection of the upper housing, the lower housing, and the core bracket to form a glue groove. The glue groove includes at least two intersecting paths. The glue groove is filled with a sealant to extend a glue path of the core assembly and expand application scenarios of the waterproof earphone.

### CROSS REFERENCE TO RELATED APPLICATIONS

This application is a continuation of International Application No. PCT/CN2023/143663 filed on Dec. 29, 2023, the entire contents of which are incorporated herein by reference.

### TECHNICAL FIELD

The present disclosure relates to the field of waterproof earphones, and in particular to, a core assembly of a waterproof earphone and a waterproof earphone using the core assembly.

### BACKGROUND

With the rapid development of consumer electronic products, electronic products such as smartphones and earphones have become a part of people's lives. Among them, an earphone, as a conversion unit, can receive an electrical signal from a media player or a receiver and convert the electrical signal into a sound wave that can be heard by a human ear, so that a user can clearly hear the sound wave in a noisy environment. The earphones are used in a wide range of scenarios. Among the many usage scenarios, there are some specific usage scenarios (e.g., scenarios of using earphones in outdoor rain or while swimming) in which the earphones are required to have good waterproof performance, especially for a core assembly of the earphones.

Therefore, a core assembly with better waterproof performance and a waterproof earphone including the core assembly are needed.

### SUMMARY

In a first aspect, one or more embodiments of the present disclosure provide a core assembly of a waterproof earphone. The core assembly includes a housing and a core module. The housing includes an upper housing and a lower housing. The upper housing and the lower housing are connected to form an accommodating cavity. The core module includes a core bracket and a core. The core is mounted on the core bracket. The core bracket is mounted in the accommodating cavity. A gap is provided at a connection among the upper housing, the lower housing, and the core bracket to form a glue groove. The glue groove includes at least two intersecting paths and is filled with a sealant.

According to some embodiments of the present disclosure, the at least two intersecting paths comprise a first gap and a second gap intersected with each other. The first gap is distributed along a circumferential direction of the housing. A depth direction of the first gap comprises an arrangement direction of the upper housing and the lower housing. The second gap is distributed along the circumferential direction of the housing. A depth direction of the second gap comprises a direction extending from an edge of the housing toward a center of the housing.

According to some embodiments of the present disclosure, the lower housing comprises a first mounting portion. The first mounting portion comprises: a first mounting surface, facing the upper housing and sealedly connected to the upper housing; and a first side wall, intersecting with the first mounting surface and facing the accommodating cavity. The upper housing comprises a second mounting portion. The second mounting portion comprises: a second mounting surface, facing the lower housing and sealedly connected to the first mounting surface via the sealant; and a second side wall, intersecting with the second mounting surface and facing away from the accommodating cavity. The second side wall and the first side wall are disposed opposite to each other, and the first gap exists between the second side wall and the first side wall.

According to some embodiments of the present disclosure, the upper housing further comprises a positioning portion located on the second side wall and protruding in a direction away from the second side wall.

According to some embodiments of the present disclosure, the positioning portion is located at a position of the second side wall close to the second mounting surface. In a direction in which the second side wall extends toward the lower housing, a size of the second side wall is greater than a size of the positioning portion.

According to some embodiments of the present disclosure, the positioning portion comprises a plurality of positioning blocks, and the plurality of positioning blocks are spaced apart along a circumferential direction of the housing.

According to some embodiments of the present disclosure, the lower housing further comprises a third mounting portion. The third mounting portion comprises a third mounting surface intersecting with the first side wall and facing the upper housing. The third mounting surface is far away from the upper housing relative to the first mounting surface. The core bracket is mounted on the third mounting surface. The core bracket and the third mounting surface are sealedly connected via the sealant.

According to some embodiments of the present disclosure, the upper housing further comprises an end surface facing the lower housing. The second gap exists between the end surface and the core bracket.

According to some embodiments of the present disclosure, the core bracket comprises a positioning end mating with the first side wall and sealingly connected to the third mounting surface. The positioning end comprises: a first surface, facing the end surface, wherein the second gap exists between the first surface and the end surface; and a second surface, facing the first side wall. A third gap exists between the second surface and the first side wall. The at least two intersecting paths further comprise the third gap. The third gap is in communication with the first gap and the second gap, and the first gap and the third gap are located at two sides of the second gap.

According to some embodiments of the present disclosure, the third gap is distributed along the circumferential direction of the housing, and a depth direction of the third gap comprises the arrangement direction of the upper housing and the lower housing.

According to some embodiments of the present disclosure, a depth of the first gap is in a range of 0.4 mm to 4 mm.

According to some embodiments of the present disclosure, a ratio of the depth of the first gap to a width of the first gap is in a range of 4 to 6.

According to some embodiments of the present disclosure, a ratio of the depth of the first gap to a depth of the second gap is in a range of 2 to 3.

According to some embodiments of the present disclosure, a width of the second gap is in a range of 0.05 mm to 0.2 mm.

According to some embodiments of the present disclosure, a ratio of the depth of the second gap to the width of the second gap is in a range of 4 to 6.5.

According to some embodiments of the present disclosure, a ratio of the width of the first gap to the width of the second gap is in a range of 2 to 3.

In a second aspect, one or more embodiments of the present disclosure provide a waterproof earphone. The waterproof earphone includes an ear hook assembly and the core assembly as described in the first aspect of the present disclosure. The ear hook assembly comprises a cavity body and an electronic component. The electronic component is mounted in the cavity body. The core assembly is electrically connected to the electronic component.

In summary, the core assembly of the waterproof earphone and the waterproof earphone provided by the present disclosure form the glue groove by providing gaps in different directions at the connection of the upper housing, the lower housing, and the core bracket of the core assembly, so that the paths of the glue groove have multiple different directions. While extending the paths of the glue groove of the waterproof earphone, by changing the path directions of the glue groove, the glue groove has multiple intersecting paths, which can increase resistance when external water enters the interior of the core assembly and further improve the waterproof performance of the core assembly.

### BRIEF DESCRIPTION OF THE DRAWINGS

In order to more clearly illustrate the technical solutions in the embodiments of the present disclosure, the drawings used in the description of the embodiments will be briefly introduced below. Obviously, the drawings in the following description are only some embodiments of the present disclosure. For those skilled in the art, other drawings may be obtained based on these drawings without creative effort.

FIG. 1 is a schematic diagram illustrating an exemplary structure of a waterproof earphone according to some embodiments of the present disclosure.

FIG. 2 is a schematic diagram illustrating an exemplary exploded structure of a waterproof earphone according to some embodiments of the present disclosure.

FIG. 3 is a schematic diagram illustrating an exemplary front view of a core assembly according to some embodiments of the present disclosure.

FIG. 4 is a schematic diagram illustrating an exemplary exploded structure of a core assembly according to some embodiments of the present disclosure.

FIG. 5 is a schematic diagram illustrating an exemplary cross-sectional view of the core assembly shown in FIG. 3 along A-A direction according to some embodiments of the present disclosure.

FIG. 6 is a schematic diagram illustrating an exemplary enlarged view of a region J of the core assembly shown in FIG. 5 according to some embodiments of the present disclosure.

### DETAILED DESCRIPTION

The following description provides specific application scenarios and requirements of the present disclosure, and is intended to enable those skilled in the art to make and use the content of the present disclosure. For those skilled in the art, various local modifications to the disclosed embodiments are obvious, and the general principles defined herein may be applied to other embodiments and applications without departing from the spirit and scope of the present disclosure. Therefore, the present disclosure is not limited to the illustrated embodiments but is accorded the widest scope consistent with the claims.

The terminology used herein is for the purpose of describing particular example embodiments only and is not intended to be limiting. For example, as used herein, the singular forms “a,” “an,” and “the” may also include the plural forms unless the context clearly dictates otherwise. As used in the present disclosure, the terms “include,” “comprise,” and/or “contain” mean that the associated integer, step, operation, element, and/or component is present, but do not preclude the presence or addition of one or more other features, integers, steps, operations, elements, components, and/or groups in the system/method.

In the present disclosure, the expression “X includes at least one of A, B, or C” means that X includes at least A, or X includes at least B, or X includes at least C. That is, X may include only any combination of A, B, and C, or may simultaneously include any combination of A, B, and C and other possible content/elements. The any combination of A, B, and C may be A, B, C, AB, AC, BC, or ABC.

In the present disclosure, unless explicitly stated, the association relationship between structures may be a direct association relationship or an indirect association relationship. For example, when describing “A is connected to B,” unless it is explicitly stated that A is directly connected to B, it should be understood that A may be directly connected to B or indirectly connected to B. As another example, when describing “A is above B,” unless it is explicitly stated that A is directly above B (A and B are adjacent and A is above B), it should be understood that A may be directly above B, or A may be indirectly above B (other elements are interposed between A and B, and A is above B), and so on.

In view of the following description, these and other features of the present disclosure, the operation and function of related elements of the structure, and the combination of parts and the economy of manufacture may be significantly improved. The description also includes all graphics and text in the drawings referenced in the present disclosure, all of which form a part of the present disclosure. However, it should be clearly understood that the drawings are for the purpose of illustration and description only and are not intended to limit the scope of the present disclosure. It should also be understood that the drawings are not drawn to scale.

In the related art of electrical signals, waterproofing of an earphone is achieved by applying waterproof glue at a connection between an upper housing and a lower housing of a core assembly. In this manner, a glue storage amount is relatively low and a glue groove path is relatively short, resulting in poor waterproof performance. Especially in swimming scenarios, the waterproof earphone needs to withstand liquid pressure from water. Under the action of the liquid pressure, water may enter the interior of the earphone through a gap between the upper housing and the lower housing and erode circuit components.

The present disclosure provides a core assembly of a waterproof earphone and the waterproof earphone, which increases a glue storage path of the waterproof earphone and improves the waterproof performance of the waterproof earphone. The waterproof earphone may be any type of earphone. For example, the waterproof earphone may be a wired earphone. In the wired earphone, a receiver may receive an electrical signal from a media player through a wired transmission manner, thereby converting the electrical signal into a sound wave that can be heard by a human ear. As another example, the waterproof earphone may be a wireless earphone. In the wireless earphone, a receiver may receive the electrical signal from the media player through a wireless transmission manner, thereby converting the electrical signal into the sound wave that can be heard by the human ear. The waterproof earphone may be an air conduction earphone. The air conduction earphone may convert the electrical signal into an air vibration signal. The air vibration signal may be transmitted to an ear canal of an ear. The eardrum in the ear may convert the air vibration signal into a sound. As another example, the waterproof earphone may be a bone conduction earphone. The bone conduction earphone may convert the electrical signal into a mechanical vibration signal. The mechanical vibration signal may cause vibration of a skull, cause the perilymph to produce fluctuations of the same frequency, and excite the spiral organ of the cochlea to produce hearing. As still another example, the waterproof earphone may be a combination of the air conduction earphone and the bone conduction earphone. In some embodiments, the waterproof earphone may also include a data storage unit. In this situation, the waterproof earphone may not rely on an external media player, and may play audio data stored in the built-in data storage unit without a signal transmission with the external media player. The present disclosure does not limit the type of the waterproof earphone.

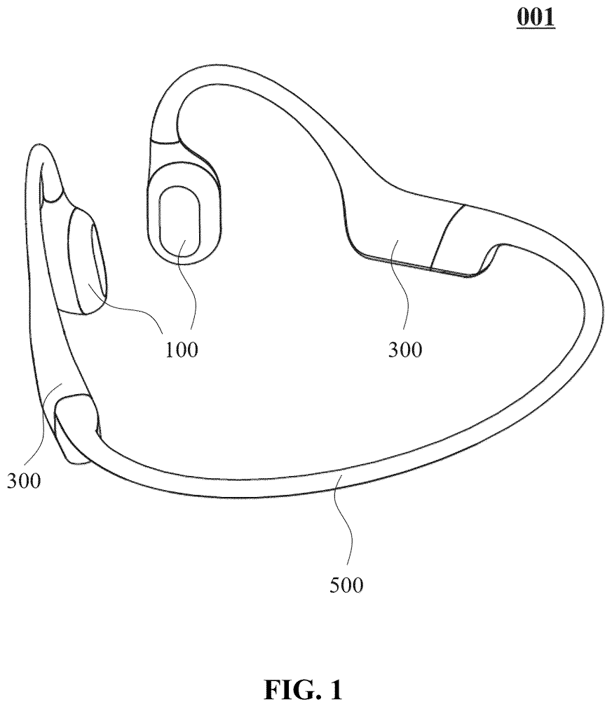

FIG. 1 is a schematic diagram illustrating an exemplary structure of a waterproof earphone according to some embodiments of the present disclosure. As shown in FIG. 1, the waterproof earphone 001 may include a core assembly 100 and an ear hook assembly 300. In some embodiments, the waterproof earphone 001 may further include a rear hook assembly 500.

The core assembly 100 may also be referred to as a speaker assembly. The core assembly 100 may convert an electrical signal into an acoustic signal that can be heard by human. A count of the core assembly 100 may be one or two. When the count of the core assembly 100 is one, the waterproof earphone 001 may be applicable to some application scenarios that do not require particularly high stereo sound, for example, hearing aids for hearing patients and teleprompters for hosts. When a user wears the waterproof earphone 001, the core assembly 100 may be worn on a left ear of the user or may be worn on a right ear of the user. When the count of the core assembly 100 is two, when the user wears the waterproof earphone 001, the two core assemblies 100 are worn on different ears of the user, respectively. In this situation, both of the two core assemblies 100 may emit sound, so that the waterproof earphone 001 has a stereo sound effect, improving user satisfaction with the waterproof earphone 001. In some embodiments, the two core assemblies 100 may be independently arranged. That is, the two core assemblies 100 may exist independently and may be worn separately. For example, the two core assemblies 100 may be worn on different ears, respectively, or worn on ears of different users, respectively, making the use of the waterproof earphone 001 more flexible. In this situation, the two core assemblies 100 may work independently. In some embodiments, the two core assemblies 100 may also be connected together (e.g., connected together via the rear hook assembly 500). In this situation, the two core assemblies 100 may work simultaneously and achieve unified control to obtain better sound effects. In some embodiments, the core assembly 100 may be an air conduction core. In this situation, when the user wears the waterproof earphone 001, the core assembly 100 may be in-ear type or open type. In some embodiments, the core assembly 100 may also be a bone conduction core. In this situation, when the user wears the waterproof earphone 001, the core assembly 100 may be hung on an outer side of the ear of the user. For example, the core assembly 100 may be hung on the outer side of the ear and close to human skin to transmit sound waves to an interior of the ear through vibrations of the human skin and bones. In some embodiments, the core assembly 100 may be a combination of the air conduction core and the bone conduction core.

The ear hook assembly 300 may be electrically connected to the core assembly 100 to achieve control of the core assembly 100. In some embodiments, the ear hook assembly 300 may receive an electrical signal sent by an external media player and send the electrical signal to the core assembly 100. In some embodiments, the ear hook assembly 300 may include a built-in data storage unit. In this situation, the ear hook assembly 300 may send audio data of the built-in data storage unit to the core assembly 100. A count of the ear hook assembly 300 may be one or two. In some embodiments, each core assembly 100 may be connected to one ear hook assembly 300. In some embodiments, two core assemblies 100 may share one ear hook assembly 300. When the waterproof earphone 001 includes two core assemblies 100 and two ear hook assemblies 300, the two core assemblies 100 are electrically connected to the two ear hook assemblies 300, respectively. In this situation, the two ear hook assemblies 300 may be independently set to achieve separate control of the core assembly 100. The two ear hook assemblies 300 may also be connected together, for example, the two ear hook assemblies 300 are connected together via the rear hook assembly 500 to achieve unified control of the two core assemblies 100.

In some embodiments, the waterproof earphone 001 may further include the rear hook assembly 500. The rear hook assembly 500 may connect the two core assemblies 100. For example, when the two core assemblies 100 are electrically connected to the two ear hook assemblies 300, respectively, the rear hook assembly 500 may electrically connect the two ear hook assemblies 300. As another example, when the two core assemblies 100 share one ear hook assembly 300, the ear hook assembly 300 may be close to any one of the two core assemblies 100, and the rear hook assembly 500 may electrically connect the ear hook assembly 300 to the other one of the two core assemblies 100.

In some embodiments, the rear hook assembly 500 may include a cable. The cable may be any conductive wire material (e.g., a conducting wire). The cable is mainly used to achieve electrical connection between various electronic components of the waterproof earphone 001. For example, when the two core assemblies 100 are electrically connected to the two ear hook assemblies 300, respectively, the cable may electrically connect the two ear hook assemblies 300. As another example, when the two core assemblies 100 share one ear hook assembly 300, the ear hook assembly 300 may be close to any one of the two core assemblies 100, and the cable may electrically connect the ear hook assembly 300 to the other one of the two core assemblies 100. The cable may be a single strand or a plurality of strands. When a plurality of circuits in the waterproof earphone 001 need to be electrically connected, the cable may be correspondingly set as a plurality of strands, for example, the cable may be set as any number of strands such as 1 strand, 2 strands, 3 strands, 5 strands, 6 strands, or 8 strands.

In some embodiments, the rear hook assembly 500 may also include an elastic metal wire. The elastic metal wire may adopt an arc design to provide a certain clamping force when the user wears the earphone. For example, when the two core assemblies 100 are electrically connected to the two ear hook assemblies 300, respectively, two ends of the elastic metal wire may be connected to the two ear hook assemblies 300, respectively. In this situation, when the user wears the waterproof earphone 001, the two ear hook assemblies 300 may be hung on outer sides of two ears of the user, respectively, the rear hook assembly 500 is used to be wound around a rear side of the head of the user, and the two core assemblies 100 are located near the two ears, respectively. In this situation, the elastic metal wire may provide a certain clamping force to make the two core assemblies 100 fit tightly to the skin of the user to improve wearing reliability.

In some embodiments, the waterproof earphone 001 may further include a protective cover. The protective cover may be coated on an outer surface of the core assembly 100. The protective cover may also be coated on an outer surface of the ear hook assembly 300. The protective cover may also be coated on an outer surface of the rear hook assembly 500. The protective cover may be integrally formed or may be formed by splicing a plurality of protective covers. The protective cover and the core assembly 100, the ear hook assembly 300, and the rear hook assembly 500 may be sealedly connected via a sealant to improve waterproof performance of the waterproof earphone 001. The protective cover may be made of a soft material having a certain elasticity, for example, soft silica gel and rubber.

It should be noted that a connection between the core assembly 100 and the ear hook assembly 300 may also be sealedly connected via the sealant to improve the waterproof performance of the waterproof earphone 001. Similarly, a connection between the ear hook assembly 300 and the rear hook assembly 500 may also be sealedly connected via the sealant to improve the waterproof performance of the waterproof earphone 001.

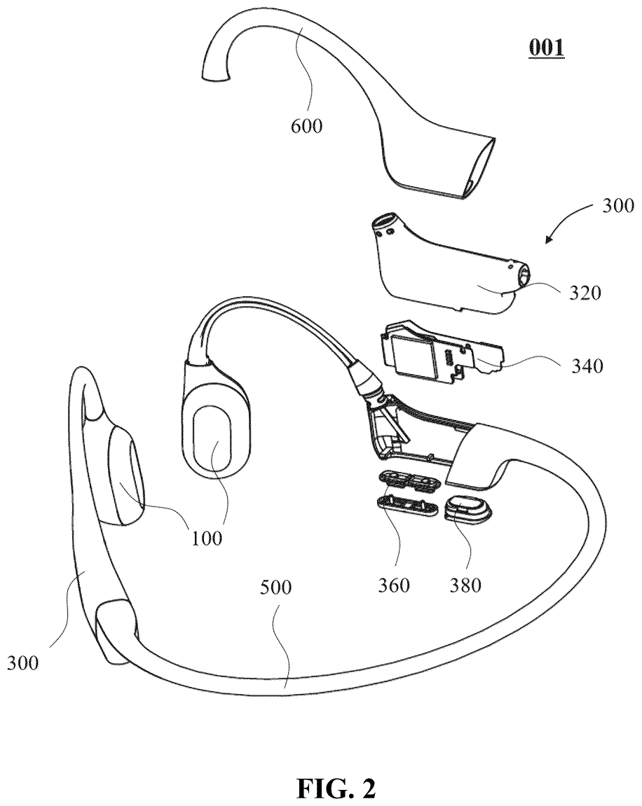

FIG. 2 is a schematic diagram illustrating an exemplary exploded structure of a waterproof earphone according to some embodiments of the present disclosure. As shown in FIG. 2, the ear hook assembly 300 may include a cavity body 320 and an electronic component 340. A protective cover 600 shown in FIG. 2 may be a protective cover coated on the outer surface of the ear hook assembly 300.

The cavity body 320 may be a mounting base of the ear hook assembly 300. Other components (e.g., the electronic component 340) of the ear hook assembly 300 may be mounted with the cavity body 320 as a carrier. The cavity body 320 may include a main cavity body 321 and a cavity body upper cover 323. The main cavity body 321 and the cavity body upper cover 323 may be installed together and form an accommodating cavity inside. For example, the electronic component 340 may be installed inside the cavity body 320, for example, in the accommodating cavity. A connection between the main cavity body 321 and the cavity body upper cover 323 may be sealedly connected by a sealant to improve waterproof performance of the cavity body 320. A shape of the cavity body 320 may be any shape to accommodate installation of other components. The shape of the cavity body 320 may be an ergonomic shape to facilitate use by a user and reading of data. A material of the cavity body 320 may be any material, for example, a metal material, a plastic material, or a polymer material. The present disclosure does not limit the shape and the material of the cavity body 320.

The electronic component 340 may include a circuit board. The core assembly 100 may be electrically connected to the circuit board. The core assembly 100 and the circuit board may be electrically connected via a cable. The circuit board may control the core assembly 100. The circuit board is a chip integrated circuit that integrates earphone functions. In some embodiments, the circuit board includes a radio frequency unit for receiving and transmitting signals, such as communication components like Bluetooth, near field communication (NFC), Wi-Fi, etc., to achieve communication with an external media player. In some embodiments, the circuit board includes a central processing unit (CPU) unit for processing data and a digital signal processor (DSP) unit for audio decoding. In some embodiments, the circuit board further includes a data storage unit for storing audio data. The circuit board may be used for short-range wireless communication, audio transmission, data transmission, data storage, location services, device networking, etc. The present disclosure does not limit the type of the circuit board. Specifically, the circuit board may include a flexible printed circuit (FPC), a printed circuit board (PCB), and a rigid-flex printed circuit board (Rigid-Flex PCB). That is, the circuit board may be any circuit or processor capable of performing one or more functions, or any combination thereof.

In some embodiments, the ear hook assembly 300 may further include a control button 360. The control button 360 may be installed on the cavity body 320 and partially exposed outside the cavity body 320 for operation by a user. The control button 360 may be electrically connected to the circuit board. A user may operate the control button 360 to control the circuit board, thereby controlling the waterproof earphone 001 to implement functions such as turning on, turning off, volume adjustment, and mode switching, which improves the intelligence level of the waterproof earphone 001 and enhances the user experience.

In some embodiments, the ear hook assembly 300 may further include a charging interface 380. The charging interface 380 may be installed on the cavity body 320 and partially exposed outside the cavity body 320 to be electrically connected to an external power source. The charging interface 380 may be electrically connected to the circuit board to provide electrical energy to the circuit board. The electrical energy may be transmitted to other components (e.g., the core assembly 100) via the circuit board.

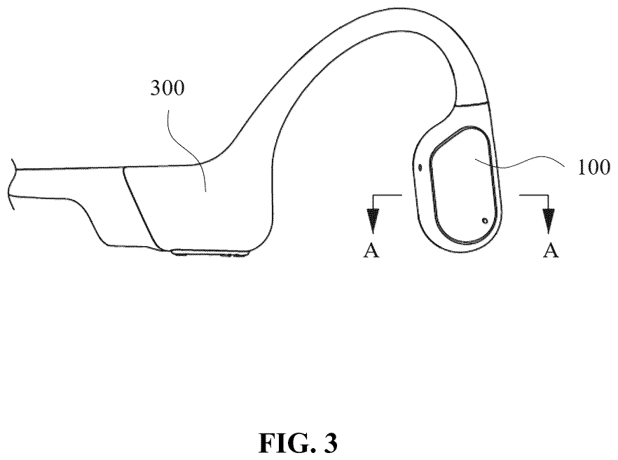

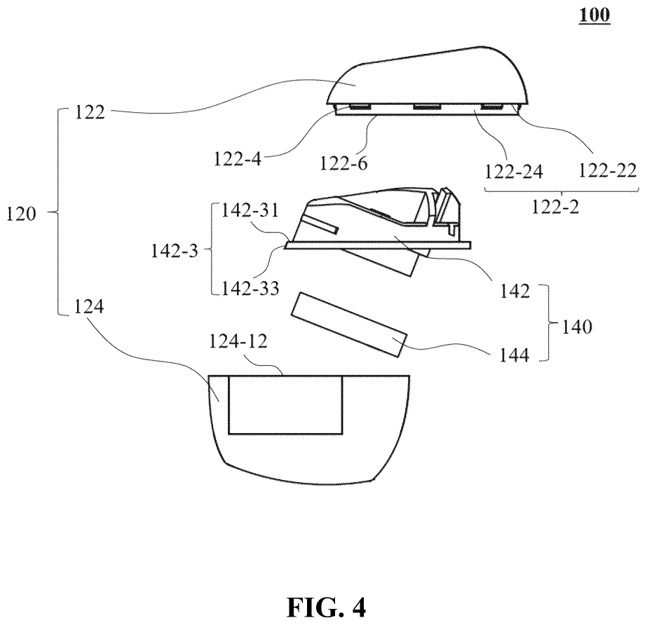

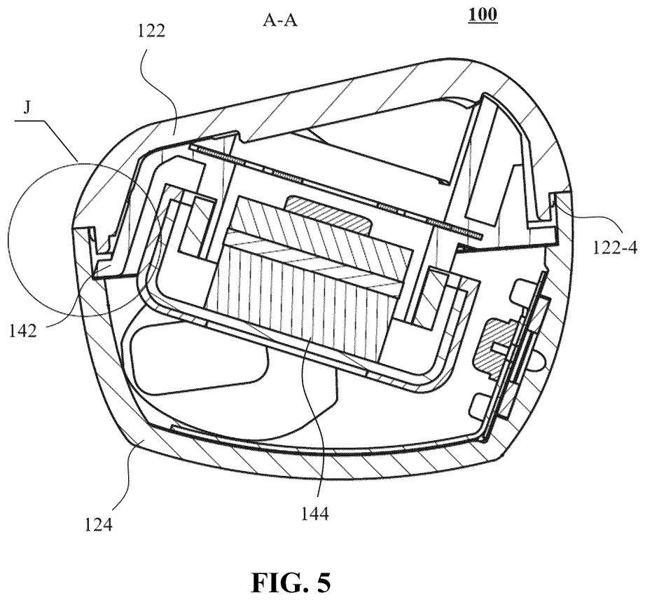

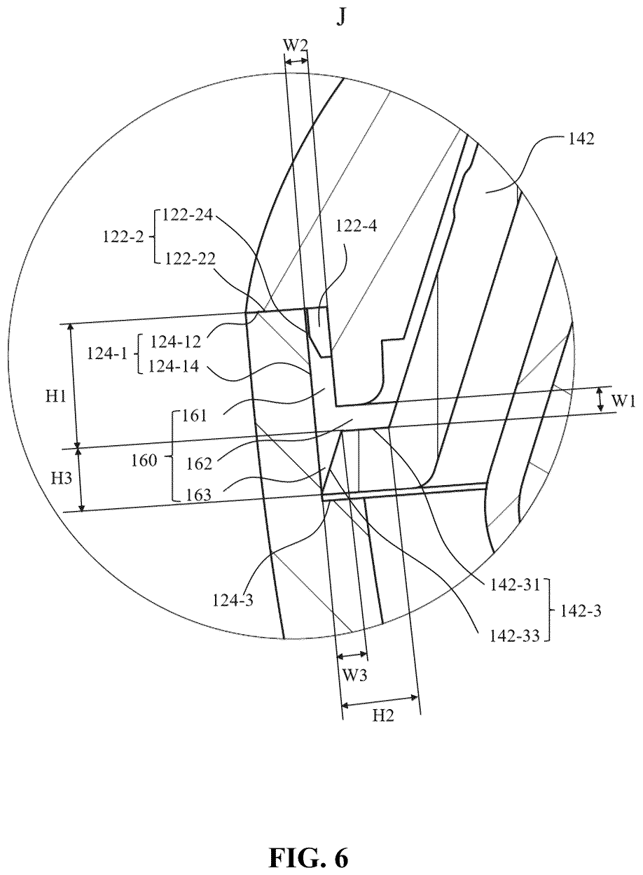

FIG. 3 is a schematic diagram illustrating an exemplary front view of a core assembly according to some embodiments of the present disclosure. FIG. 4 is a schematic diagram illustrating an exemplary exploded structure of a core assembly according to some embodiments of the present disclosure. FIG. 5 is a schematic diagram illustrating an exemplary cross-sectional view of the core assembly shown in FIG. 3 along A-A direction according to some embodiments of the present disclosure. FIG. 6 is a schematic diagram illustrating an exemplary cross-sectional view of the core assembly shown in FIG. 3 along A-A direction according to some embodiments of the present disclosure. As shown in FIG. 3 to FIG. 6, the core assembly 100 includes a housing 120 and a core module 140.

The housing 120 includes an upper housing 122 and a lower housing 124. The upper housing 122 and the lower housing 124 are thin-walled components. The upper housing 122 and the lower housing 124 are connected to form an accommodating cavity 125. The core module 140 is installed in the accommodating cavity 125. The upper housing 122 and the lower housing 124 are sealedly connected to provide waterproof and dustproof protection for the core module 140.

The core module 140 includes a core bracket 142 and a core 144. The core bracket 142 and the core 144 are both located in the accommodating cavity 125. The core 144 is installed on the core bracket 142 and is electrically connected to the circuit board via a cable to receive electrical signals transmitted by the circuit board and convert the electrical signals into sound waves audible to human.

In some embodiments, the core 144 includes a bone conduction core. The bone conduction core may include a bone conduction transducer. The bone conduction transducer includes a vibrator. The bone conduction transducer may convert the electrical signals into mechanical vibration of the vibrator. The bone conduction transducer may be connected to the housing 120 via the core bracket 142. When the waterproof earphone 001 is worn, the bone conduction core may directly contact the user's skin (e.g., a cheek) via the housing 120, thereby transmitting the mechanical vibration to the user's skin, which propagates through the user's skull to the cochlea to produce hearing. The bone conduction core may allow the user to receive sound waves while the user's external auditory canal is open.

In some embodiments, the bone conduction core may further include a diaphragm. The diaphragm is connected between the bone conduction transducer and the housing 120 to divide the accommodating cavity 125 into a front cavity close to a skin contact area and a rear cavity away from the skin contact area. The housing 120 is provided with a sound outlet hole communicating with the rear cavity, and the diaphragm generates air-conducted sound that is transmitted to the human ear through the sound outlet hole during a relative movement between the bone conduction transducer and the housing 120. In this situation, the core 144 may generate both bone-conducted sound and air-conducted sound.

In some embodiments, the core 144 includes an air conduction core. The air conduction core may include an air conduction transducer. The air conduction transducer may convert the electrical signals into air vibration. The air vibration enters the user's ear through the sound outlet hole on the housing 120.

In some embodiments, the core 144 includes both the bone conduction core and the air conduction core.

Additionally, the core assembly 100 described in the present disclosure may further include an acoustic transducer, such as a microphone or a sound pickup device. For example, the acoustic transducer, such as the microphone or the sound pickup device, may be installed in the accommodating cavity 125.

In a molding stage, the upper housing 122, the lower housing 124, and the core bracket 142 may be integrally molded or separately molded and then assembled together. The integral molding may adopt processes such as injection molding, stamping, or die casting to directly mold the upper housing 122, the lower housing 124, and the core bracket 142 around the core 144. When separately molded, the upper housing 122, the lower housing 124, and the core bracket 142 may be molded separately first. Then, the lower housing 124 and the core bracket 142 are connected together first, and then the connected lower housing 124 and core bracket 142 are connected to the upper housing 122. When separately molded, the upper housing 122, the lower housing 124, and the core bracket 142 are sealed and connected by a sealant to improve the waterproof effect of the core assembly 100. For convenience of illustration, the following description uses an example where the upper housing 122, the lower housing 124, and the core bracket 142 are separately molded and then assembled together.

As shown in FIG. 4 and FIG. 6, when the upper housing 122, the lower housing 124, and the core bracket 142 are connected, a gap is provided at a connection among the upper housing 122, the lower housing 124, and the core bracket 142 to form a glue groove 160. The glue groove 160 includes at least two intersecting paths. To improve the waterproof performance of the core assembly 100, the glue groove 160 is filled with the sealant for sealing.

The lower housing 124 may include a first mounting portion 124-1. The first mounting portion 124-1 is configured to be mounted to the upper housing 122. The first mounting portion 124-1 is located at an end of the lower housing 124 facing the upper housing 122. As described above, the lower housing 124 is a thin-walled component. The first mounting portion 124-1 is configured to be circumferentially continuous and closed along the lower housing 124 to achieve a sealed connection with the upper housing 122. It should be noted that “circumferentially continuous” may mean that the first mounting portion 124-1 is continuous along the lower housing 124 without any interruption; “closed” may mean that the first mounting portion 124-1 is connected end to end along the lower housing 124 to form an annular closed portion.

The first mounting portion 124-1 may include a first mounting surface 124-12. The first mounting surface 124-12 faces the upper housing 122. The first mounting surface 124-12 may be a plane at an end of the first mounting portion 124-1 facing the upper housing 122. The first mounting surface 124-12 may be a circumferentially continuous and closed surface along the lower housing 124.

The first mounting portion 124-1 may further include a first side wall 124-14. The first side wall 124-14 intersects with the first mounting surface 124-12 and faces the accommodating cavity 125. The first side wall 124-14 may be a circumferentially continuous and closed surface along the lower housing 124. The first mounting surface 124-12 and the first side wall 124-14 are connected to each other to jointly form a part of the thin wall of the lower housing 124.

The lower housing 124 may further include a third mounting portion 124-3. The core bracket 142 may be mounted on the third mounting portion 124-3. The third mounting portion 124-3 is located away from the upper housing 122 relative to the first mounting portion 124-1 and is closer to a center of the accommodating cavity 125. That is, the third mounting portion 124-3 is closer to an interior of the accommodating cavity 125 than the first mounting portion 124-1, and a width of the third mounting portion 124-3 along a circumferential direction of the housing is greater than a width of the first mounting portion 124-1 along the circumferential direction of the housing. The third mounting portion 124-3 is configured to be circumferentially continuous and closed along the lower housing 124 to achieve a sealed connection with the core bracket 142. It should be noted that “circumferentially continuous” may mean that the third mounting portion 124-3 is continuous along the lower housing 124 without any interruption; “closed” may mean that the third mounting portion 124-3 is connected end to end along the lower housing 124 to form an annular closed portion.

In some embodiments, the third mounting portion 124-3 may include a third mounting surface 124-3. The third mounting surface 124-3 may intersect with the first side wall 124-14 and face the upper housing 122. The third mounting surface 124-3 is located away from the upper housing 122 relative to the first mounting surface 124-12. The third mounting surface 124-3 may be a circumferentially continuous and closed surface along the lower housing 124. When the core bracket 142 is connected to the lower housing 124, the core bracket 142 may be mounted on the third mounting surface 124-3. The core bracket 142 and the third mounting surface 124-3 may be sealedly connected by the sealant to improve the waterproof performance of the core assembly 100.

The upper housing 122 may include a second mounting portion 122-2. The second mounting portion 122-2 is configured to be mounted to the first mounting portion 124-1. The second mounting portion 122-2 is located at an end of the upper housing 122 facing the lower housing 124. As described above, the upper housing 122 is a thin-walled component. The second mounting portion 122-2 is configured to be circumferentially continuous and closed along the upper housing 122 to achieve a sealed connection with the lower housing 124. It should be noted that “circumferentially continuous” may mean that the second mounting portion 122-2 is continuous along the upper housing 122 without any interruption; “closed” may mean that the second mounting portion 122-2 is connected end to end along the upper housing 122 to form an annular closed portion.

The second mounting portion 122-2 may include a second mounting surface 122-22. The second mounting surface 122-22 faces the lower housing 124. The second mounting surface 122-22 may be a part of a plane at an end of the second mounting portion 122-2 facing the lower housing 124. The second mounting surface 122-22 may be a circumferentially continuous and closed surface along the upper housing 122. When the upper housing 122 is connected to the lower housing 124, the first mounting surface 124-12 abuts against the second mounting surface 122-22. To prevent water from entering the interior of the accommodating cavity 125 through an abutting portion between the first mounting surface 124-12 and the second mounting surface 122-22, the first mounting surface 124-12 and the second mounting surface 122-22 are sealedly connected by the sealant.

The second mounting portion 122-2 may further include a second side wall 122-24. The second side wall 122-24 intersects with the second mounting surface 122-22 and faces away from the accommodating cavity 125. The second side wall 122-24 may be a circumferentially continuous and closed surface along the upper housing 122. The second mounting surface 122-22 and the second side wall 122-24 are connected and together constitute a part of a thin wall of the upper housing 122.

When the upper housing 122 is connected to the lower housing 124, the second side wall 122-24 and the first side wall 124-14 are disposed opposite to each other. A first gap 161 exists between the second side wall 122-24 and the first side wall 124-14. As described above, the glue groove 160 includes at least two intersecting paths. One of the at least two intersecting paths may be the first gap 161. That is, the glue groove 160 includes the first gap 161. The first gap 161 is filled with the sealant to form a waterproof path, thereby improving the waterproof effect.

When a sealing between the first mounting surface 124-12 and the second mounting surface 122-22 fails or has a defect, external water may seep into the first gap 161 from an abutting portion between the first mounting surface 124-12 and the second mounting surface 122-22. The first gap 161, filled with the sealant, can prevent the water from continuing seeping into the housing 120, thereby improving the waterproof performance of the core assembly 100.

The first gap 161 may be distributed along a circumferential direction of the housing 120. The circumferential direction of the housing 120 may be a circumferential direction of the upper housing 122 or a circumferential direction of the lower housing 124. The first gap 161 may be continuously distributed along the circumferential direction of the housing 120. That is, the sealant accommodated in the first gap 161 may be continuously distributed along the circumferential direction of the housing 120 to form a sealed connection between the first side wall 124-14 and the second side wall 122-24. For convenience of description, a direction in which the first gap 161 is distributed along the circumferential direction is defined as a length direction of the first gap 161. A direction in which the first side wall 124-14 and the second side wall 122-24 face each other is defined as a width direction of the first gap 161. A width of the first gap 161 is W1. An arrangement direction of the upper housing 122 and the lower housing 124 is defined as a depth direction of the first gap 161. A depth of the first gap 161 is H1. The depth direction of the first gap 161 may also be a direction in which the first side wall 124-14 extends toward the upper housing 122 or a direction in which the second side wall 122-24 extends toward the lower housing 124. It should be noted that the depth direction and the width direction of the first gap 161 are determined based on a direction in which water travels. When water enters an interior of the core assembly 100 from an exterior of the core assembly 100, the water flows toward the interior of the housing 120 along the arrangement direction of the upper housing 122 and the lower housing 124. Therefore, the direction in which the water travels is defined as the depth direction of the first gap 161. A direction perpendicular to the depth direction is defined as the width direction.

The depth H1 of the first gap 161 may be equal to the width W1, greater than the width W1, or less than the width W1. In some embodiments, the depth H1 of the first gap 161 is greater than the width W1 of the first gap 161. As described above, the depth direction of the first gap 161 is the direction in which the water travels. Therefore, in scenarios such as swimming or long-term exposure to rain, increasing the depth H1 of the first gap 161 can lengthen a water ingress path, thereby increasing resistance to water ingress and improving the waterproof effect. Moreover, reducing the width W1 of the first gap is also conducive to increasing the resistance to water ingress and improving the waterproof effect. Meanwhile, the depth H1 of the first gap 161 being greater than the width W1 of the first gap 161 allows the sealant more easily to squeeze into the first gap 161 and enables the sealant to fill the entire first gap 161 more uniformly, thereby further improving the waterproof effect.

The depth H1 may be in a range of 0.4 mm to 6 mm. Furthermore, the depth H1 may be in a range of 0.4 mm to 4 mm. The depth H1 being too small may result in a short length of the waterproof path, as well as an insufficient amount of the sealant filling the first gap 161, leading to a poor waterproof effect. The depth H1 being too large may affect the thickness or structural strength of the lower housing 124, and also prevent the sealant from filling the entire first gap 161. In addition, the width W1 may be in a range of 0.1 mm to 0.5 mm. Furthermore, the width W1 may be in a range of 0.1 mm to 0.3 mm. The width W1 being too small may result in a short waterproof path and an insufficient amount of the sealant filling the first gap 161, which may prevent the sealant from overflowing to the upper end of the first gap 161 to fill the entire first gap 161. The width W1 being too long may affect the arrangement of components inside the lower housing 124. Therefore, considering all factors, a ratio of the depth H1 to the width W1 may be in a range of 4 to 6. Furthermore, the ratio of the depth H1 to the width W1 may be in a range of 4.5 to 5.5.

To improve installation convenience and accuracy of the upper housing 122 and the lower housing 124, the upper housing 122 further includes a positioning portion 122-4. The positioning portion 122-4 may be used for positioning when the upper housing 122 is installed with the lower housing 124. The positioning portion 122-4 may be located on the second side wall 122-24 and protrudes in a direction away from the second side wall 122-24. A size and a shape of the positioning portion 122-4 may match a size and a shape of the first side wall 124-14. An end of the positioning portion 122-4 away from the second side wall 122-24 may be set as a surface parallel to the second side wall 122-24 or as a surface with an angle to the second side wall 122-24. When there is an angle between the end of the positioning portion 122-4 away from the second side wall 122-24 and the second side wall 122-24, the positioning portion 122-4 can better engage with the lower housing 124 and facilitate the sealant to fill the entire glue groove 160. When the upper housing 122 is installed with the lower housing 124, the positioning portion 122-4 may engage into the first side wall 124-14. The upper housing 122 can be accurately assembled with the lower housing 124 through the positioning portion 122-4. In some embodiments, an end of the positioning portion 122-4 close to the lower housing 124 is provided with a notch, so that when the upper housing 122 and the lower housing 124 are assembled, the positioning portion 122-4 can quickly and conveniently engage into the first side wall 124-14.

As described above, the first gap 161 between the first side wall 124-14 and the second side wall 122-24 is filled with the sealant to form a sealed connection, thereby forming the waterproof path. The positioning portion 122-4 is located on the second side wall 122-24. That is, the positioning portion 122-4 is located in the first gap 161. To ensure that the first gap 161 is continuous, thereby forming a stable and reliable waterproof path, the positioning portion 122-4 cannot completely cover the second side wall 122-24. Therefore, the positioning portion 122-4 may be located close to the second mounting surface 122-22. Moreover, in a direction in which the second side wall 122-24 extends toward the lower housing 124 (i.e., the depth direction of the first gap 161), a size of the second side wall 122-24 is greater than a size of the positioning portion 122-4. Therefore, in the depth direction of the first gap 161, the positioning portion 122-4 cannot completely cover the second side wall 122-24. Therefore, at least a portion of the second side wall 122-24 is exposed outside the positioning portion 122-4 and faces the first side wall 124-14 to form the first gap 161.

In addition, to further increase the surface area and volume of the first gap 161, the positioning portion 122-4 may include a plurality of positioning blocks. The plurality of positioning blocks are spaced apart along a circumferential direction (a circumferential direction of the upper housing 122) of the housing 120. In this situation, parts among the plurality of positioning blocks are referred to as a part of the first gap 161, which is filled with the sealant. Therefore, both the surface area and the volume of the first gap 161 can be increased, and the waterproof performance can be further improved.

The upper housing 122 may further include an end surface 122-6. The end surface 122-6 may face the lower housing 124. The end surface 122-6 may intersect with the second side wall 122-24 and face the lower housing 124. The end surface 122-6 may be a circumferentially continuous and closed surface along the upper housing 122. As described above, the upper housing 122 is the thin-walled component. The end surface 122-6 may be an end of the upper housing 122 facing the lower housing 124. As described above, the core bracket 142 is installed inside the accommodating cavity 125. A second gap 162 exists between the end surface 122-6 and the core bracket 142.

Specifically, the core bracket 142 may include a positioning end 142-3. When the core bracket 142 is installed with the third mounting portion 124-3, the positioning end 142-3 of the core bracket 142 may be installed on the third mounting surface 124-3. The positioning end 142-3 of the core bracket 142 and the third mounting surface 124-3 are sealed and connected by the sealant to improve the waterproof performance of the core assembly 100.

The positioning end 142-3 may include a first surface 142-33. The first surface 142-33 may be a circumferentially continuous and closed surface along the core bracket 142. The first surface 142-33 may be a surface facing the upper housing 122. The first surface 142-33 may face the end surface 122-6. The second gap 162 exists between the first surface 142-33 and the end surface 122-6. The second gap 162 is filled with the sealant to form the waterproof path and improve the waterproof effect.

As described above, the glue groove 160 may include the at least two intersecting paths. The intersecting paths may be paths that are connected but have different directions. The at least two intersecting paths may include the second gap 162. The second gap 162 may intersect with the first gap 161. That is, the second gap 162 is connected to the first gap 161 and has a different direction. The second gap 162 and the first gap 161 form the waterproof path to improve the waterproof effect. The waterproof path sequentially includes the first gap 161 and the second gap 162 from outside to inside. When a sealing of the first gap 161 fails or has a defect, water enters the second gap 162 from the first gap 161. However, the second gap 162 is filled with the sealant, which can prevent water from continuing penetrating into the housing 120, thereby improving the waterproof performance of the core assembly 100.

The second gap 162 may be distributed along a circumferential direction of the housing 120. The circumferential direction of the housing 120 may be the circumferential direction of the upper housing 122 or the circumferential direction of the lower housing 124. The second gap 162 may be continuously distributed along the circumferential direction of the housing 120. That is, the sealant accommodated in the second gap 162 may be continuously distributed along the circumferential direction of the housing 120 to form the sealed connection between the end surface 122-6 and the first surface 142-31. For convenience of description, a direction in which the second gap 162 is distributed along the circumference is defined as a length direction of the second gap 162. A direction in which the end surface 122-6 and the first surface 142-31 face each other is defined as a width direction of the second gap 162. A width of the second gap 162 is W2. A direction in which the end surface 122-6 and the first surface 142-31 extend from outside toward center is defined as a depth direction of the second gap 162. A depth of the second gap 162 is H2. The width W2 is in a range of 0.05 mm to 0.2 mm. It should be noted that the depth direction and the width direction of the second gap 162 are determined based on the direction in which water travels. When water enters the interior of the core assembly 100 from the exterior of the core assembly 100, it flows through the first gap 161 and then flows toward the interior of the housing 120 in a direction in which the housing 120 extends from outside to center. Therefore, the direction in which the water travels is defined as the depth direction of the second gap 162. A direction perpendicular to the depth direction is defined as the width direction.

In some embodiments, the depth H1 of the first gap 161 is greater than the depth H2 of the second gap 162, so that the water inlet resistance of the first gap 161 is greater than that of the second gap 162, making it difficult for water to enter the first gap 161 and the second gap 162. In some embodiments, a ratio of the depth H1 to the depth H2 may be in a range of 2 to 3. Furthermore, the ratio of the depth H1 to the depth H2 may be in a range of 2.5 to 3, thereby better enhancing the waterproof performance. It should be noted that the depth H1 of the first gap 161, which is equal to or less than the depth H2 of the second gap, is also within the scope of protection of the present disclosure. These two situations also have very good waterproof effects.

The depth H2 of the second gap 162 may be equal to the width W2, greater than the width W2, or less than the width W2. In some embodiments, the depth H2 of the second gap 162 is greater than the width W2 of the second gap 162. As described above, the depth direction of the second gap 162 is the direction in which the water travels. Therefore, increasing the depth H2 of the second gap 162 can lengthen the water ingress path, thereby increasing the resistance to water ingress and improving the waterproof effect. Moreover, reducing the width W2 of the second gap is also beneficial for increasing the resistance to water ingress and improving the waterproof effect. Meanwhile, the depth H2 of the second gap 162 being greater than the width W2 of the second gap 162 can make it easier for the sealant to squeeze into the second gap 162, and enable the sealant more uniformly to fill the entire second gap 162, thereby further improving the waterproof effect.

In order to ensure the filling amount of the sealant and the waterproof effect of the second gap, the width W2 may be in a range of 0.05 mm to 0.2 mm. Furthermore, the width W2 may be in a range of 0.1 mm to 0.2 mm. A ratio of the depth H2 to the width W2 may be in a range of 4-6.5. Furthermore, the ratio of the depth H2 to the width W2 may be in a range of 5.5-6.5.

As described above, the glue groove 160 may include the intersecting first gap 161 and second gap 162. The first gap 161 and the second gap 162 have different depth directions, such that the first gap 161 and the second gap 162 form an L-shaped glue groove. Compared with a linear glue groove, the L-shaped glue groove increases resistance to water ingress by changing a direction of a water ingress path, and facilitates the application of glue, thereby improving the waterproof effect. In some embodiments, the width W1 of the first gap 161 may be greater than the width W2 of the second gap 162. In some embodiments, a ratio of the width W1 to the width W2 may be in a range of 2 to 3. In some embodiments, the ratio of the width W1 to the width W2 may be in a range of 1.5 to 2, such that it is easier for the sealant to squeeze from the second gap 162 into the first gap 161, thereby allowing the sealant to fill the first gap 161 and the second gap 162. It should be noted that a case where the width W1 of the first gap 161 is equal to the width W2 of the second gap or greater than the width W2 of the second gap is also within the protection scope of the present disclosure, and these two cases also have good waterproof effect. In some embodiments, the depth H1 of the first gap 161 is greater than the depth H2 of the second gap 162, such that the water ingress resistance of the first gap 161 is greater than the water ingress resistance of the second gap 162, thereby making it difficult for water to enter the first gap 161 and also difficult to enter the second gap 162, thus better improving waterproof performance. It should be noted that a case where the depth H1 of the first gap 161 is equal to the depth H2 of the second gap or less than the depth H2 of the second gap is also within the protection scope of the present disclosure, and these two cases also have good waterproof effect.

The positioning end 142-3 may further include a second surface 142-33. The second surface 142-33 is distributed along a circumferential direction of the core bracket 142. When the core bracket 142 is mounted at the third mounting portion 124-3, the second surface 142-33 may face the first side wall 124-14. In some embodiments, a third gap 163 exists between the second surface 142-33 and the first side wall 124-14. The third gap 163 is filled with the sealant.

As described above, the glue groove 160 may include at least two intersecting paths. The intersecting paths may be paths that are connected but have different directions. The at least two intersecting paths may include the third gap 163. The third gap 163 may intersect with the second gap 162 and the first gap 161. That is, the third gap 163, the second gap 162, and the first gap 161 are connected. The first gap 161 and the third gap 163 are located on two sides of the second gap 162. In some embodiments, when the sealing of the first gap 161 fails or has a defect, water flows from the first gap 161 along the depth direction of the first gap 161 into the third gap 163. The third gap 163, filled with the sealant, can prevent water from continuing seeping into the interior of the core assembly 100.

The third gap 163 may be distributed along a circumferential direction of the housing 120. The circumferential direction of the housing 120 may be the circumferential direction of the upper housing 122 or the circumferential direction of the lower housing 124. The third gap 163 may be continuously distributed along the circumferential direction of the housing 120. That is, the sealant accommodated in the third gap 163 may be continuously distributed along the circumferential direction of the housing 120 to form the sealed connection between the second surface 142-33 and the first side wall 124-14. For convenience of description, a direction in which the third gap 163 is distributed along the circumferential direction is defined as a length direction of the third gap 163. A direction in which the second surface 142-33 faces the first side wall 124-14 is defined as a width direction of the third gap 163. A width of the third gap 163 is W3. A direction in which the first side wall 124-14 extends is defined as a depth direction of the third gap 163. A depth of the third gap 163 is H3. It should be noted that the depth direction and the width direction of the third gap 163 are determined based on a direction in which water travels. When water enters an interior of the core assembly 100 from an exterior of the core assembly 100, it flows through the first gap 161 and then flows along an extending direction (which is also an arrangement direction of the upper housing 122 and the lower housing 124) of the first side wall 124-14 to the interior of the housing 120. Therefore, the direction in which the water travels is defined as the depth direction of the third gap 163. A direction perpendicular to the depth direction is defined as the width direction.

The depth H3 of the third gap 163 may be equal to the width W3, greater than the width W3, or less than the width W3. In some embodiments, the depth H3 of the third gap 163 is greater than the width W3 of the third gap 163. As described above, the depth direction of the third gap 163 is the direction in which the water travels. Therefore, increasing the depth H3 of the third gap 163 can lengthen a water ingress path, thereby increasing resistance to water ingress and improving the waterproof effect. Moreover, reducing the width W3 of the first gap is also conducive to increasing resistance to water ingress and improving the waterproof effect. Meanwhile, the depth H3 of the third gap 163 being greater than the width W3 of the third gap 163 allows the sealant more easily to squeeze into the third gap 163, and also allows the sealant to more uniformly fill the entire third gap 163, thereby further improving the waterproof effect.

As described above, the glue groove 160 may include the intersecting first gap 161, second gap 162, and third gap 163. The first gap 161, the second gap 162, and the third gap 163 may form a T-shaped glue groove. The T-shaped glue groove increases resistance to water ingress by changing a direction of the water ingress path and lengthening the water ingress path, thereby improving the waterproof effect. Meanwhile, the T-shaped glue groove may accommodate more sealant, allowing the sealant to fully fill the glue groove 160, further improving the waterproof effect.

It should be noted that the above-mentioned “filled” may be understood as the sealant being continuous in a length direction and a width direction of a sealed object, thereby achieving a sealing effect. When there are a plurality of sealed objects and the plurality of sealed objects are connected, “filled” may be understood as the sealant being continuous in the length direction and the width direction of each sealed object of the plurality of sealed objects, and connections among the plurality of sealed objects are also filled with the sealant continuously, without any gap not filled with the sealant.

It should be noted that gaps formed at connections among the upper housing 122, the lower housing 124, and the core bracket 142 may all be considered as part of the glue groove 160.

The sealant used for the above bonding includes instant adhesive (e.g., 502 adhesive), epoxy resin adhesive, anaerobic adhesive, UV adhesive (ultraviolet light curing type), hot melt adhesive, pressure sensitive adhesive, latex type adhesive, etc.

In summary, the present disclosure provides the core assembly 100 and the waterproof earphone 001. By providing the glue groove 160 formed by the plurality of gaps with different directions at connections among the upper housing 122, the lower housing 124, and the core bracket 142 of the core assembly 100, paths of the glue groove 160 have a plurality of different directions. By changing the path directions of the glue groove 160, the glue groove 160 has a plurality of intersecting paths, which can increase resistance when external water enters the interior of the core assembly 100, while lengthening the paths of the glue groove 160 of the waterproof earphone 001, thereby further improving the waterproof performance of the core assembly 100.

The foregoing describes specific embodiments of the present disclosure. Other embodiments are within the scope of the appended claims. In some cases, the actions or steps recited in the claims may be performed in an order different from that in the embodiments and still achieve the desired results. Additionally, the processes depicted in the drawings do not necessarily require showing a specific order or sequential order to achieve the desired results. In some embodiments, multitasking and parallel processing are also possible or may be advantageous.

In summary, after reading the present detailed disclosure, those skilled in the art will understand that the foregoing detailed disclosure is presented by way of example only and may not be limiting. Although not explicitly stated herein, those skilled in the art will understand that the present disclosure is intended to encompass various reasonable changes, improvements, and modifications to the embodiments. These changes, improvements, and modifications are intended to be proposed by the present disclosure and fall within the spirit and scope of the exemplary embodiments of the present disclosure.

Furthermore, certain terms in the present disclosure have been used to describe the embodiments of the present disclosure. For example, “an embodiment,” “embodiment,” and/or “some embodiments” mean that a particular feature, structure, or characteristic described in connection with the embodiment may be included in at least one embodiment of the present disclosure. Therefore, it may be emphasized and should be understood that two or more references to “an embodiment” or “one embodiment” or “an alternative embodiment” in various portions of the present disclosure do not necessarily all refer to the same embodiment. Moreover, particular features, structures, or characteristics may be combined in one or more embodiments of the present disclosure as appropriate.

It should be understood that, in the foregoing description of the embodiments of the present disclosure, for the purpose of facilitating understanding of a feature and simplifying the present disclosure, the present disclosure combines various features in a single embodiment, drawing, or description thereof. However, this does not mean that the combination of these features is necessary. Those skilled in the art, when reading the present disclosure, may well extract a portion of the features as a separate embodiment for understanding. That is, the embodiments in the present disclosure may also be understood as an integration of multiple sub-embodiments. The content of each sub-embodiment is also valid when it comprises fewer than all the features of a single aforementioned disclosed embodiment.

Each patent, patent application, publication of a patent application, and other material, such as articles, books, specifications, publications, documents, items, etc., cited herein may be incorporated by reference herein. For all purposes, except for any prosecution file history associated therewith, any prosecution file history that may be inconsistent or conflicting with this document, or any prosecution file history that may have a limiting effect on the broadest scope of the claims. Now or hereafter associated with this document. For example, if there is any inconsistency or conflict between the description, definition, and/or use of terms associated with any incorporated material and the description, definition, and/or use of terms in this document, the terms in the present disclosure shall prevail.

Finally, it should be understood that the embodiments of the present disclosure disclosed herein are illustrative of the principles of the embodiments of the present disclosure. Other modified embodiments are also within the scope of the present disclosure. Therefore, the embodiments disclosed in the present disclosure are by way of example only and not limitation. Those skilled in the art may adopt alternative configurations based on the embodiments in the present disclosure to implement the application in the present disclosure. Therefore, the embodiments of the present disclosure are not limited to the embodiments precisely described in the present disclosure.

1. A core assembly of a waterproof earphone, comprising:
a housing, comprising an upper housing and a lower housing, wherein the upper housing and the lower housing are connected to form an accommodating cavity; and
a core module, comprising a core bracket mounted in the accommodating cavity and a core mounted on the core bracket, wherein a gap is provided at a connection among the upper housing, the lower housing, and the core bracket to form a glue groove, the glue groove comprising at least two intersecting paths and filled with a sealant.

2. The core assembly according to claim 1, wherein the at least two intersecting paths comprise a first gap and a second gap intersected with each other, wherein
the first gap is distributed along a circumferential direction of the housing, and a depth direction of the first gap comprises an arrangement direction of the upper housing and the lower housing; and
the second gap is distributed along the circumferential direction of the housing, and a depth direction of the second gap comprises a direction extending from an edge of the housing toward a center of the housing.

3. The core assembly according to claim 2, wherein
the lower housing comprises a first mounting portion, the first mounting portion comprising:
a first mounting surface, facing the upper housing and sealingly connected to the upper housing; and
a first side wall, intersecting with the first mounting surface and facing the accommodating cavity.

4. The core assembly according to claim 18, wherein the upper housing further comprises a positioning portion located on the second side wall and protruding in a direction away from the second side wall.

5. The core assembly according to claim 4, wherein the positioning portion is located at a position of the second side wall close to the second mounting surface.

6. The core assembly according to claim 4, wherein the positioning portion comprises a plurality of positioning blocks, and the plurality of positioning blocks are spaced apart along a circumferential direction of the housing.

7. The core assembly according to claim 3, wherein the lower housing further comprises a third mounting portion, the third mounting portion comprising a third mounting surface intersecting with the first side wall and facing the upper housing, wherein
the third mounting surface is far away from the upper housing relative to the first mounting surface;
the core bracket is mounted on the third mounting surface; and
the core bracket and the third mounting surface are sealedly connected via the sealant.

8. The core assembly according to claim 2, wherein the upper housing further comprises an end surface facing the lower housing, wherein the second gap exists between the end surface and the core bracket.

9. The core assembly according to claim 8, wherein the core bracket comprises a positioning end mating with the first side wall and sealingly connected to the third mounting surface, wherein the positioning end comprises:
a first surface, facing the end surface, wherein the second gap exists between the first surface and the end surface; and
a second surface, facing the first side wall.

10. The core assembly according to claim 20, wherein the third gap is distributed along the circumferential direction of the housing, and a depth direction of the third gap comprises the arrangement direction of the upper housing and the lower housing.

11. The core assembly according to claim 2, wherein a depth of the first gap is in a range of 0.4 mm to 4 mm.

12. The core assembly according to claim 2, wherein a ratio of a depth of the first gap to a width of the first gap is in a range of 4 to 6.

13. The core assembly according to claim 2, wherein a ratio of a depth of the first gap to a depth of the second gap is in a range of 2 to 3.

14. The core assembly according to claim 2, wherein a width of the second gap is in a range of 0.05 mm to 0.2 mm.

15. The core assembly according to claim 2, wherein a ratio of a depth of the second gap to a width of the second gap is in a range of 4 to 6.5.

16. The core assembly according to claim 2, wherein a ratio of a width of the first gap to a width of the second gap is in a range of 2 to 3.

17. A waterproof earphone, comprising an ear hook assembly, the ear hook assembly comprising:
a cavity body;
an electronic component mounted in the cavity body; and
the core assembly claim 1, the core assembly being electrically connected to the electronic component.

18. The core assembly according to claim 3, wherein the upper housing comprises a second mounting portion, the second mounting portion comprising:
a second mounting surface, facing the lower housing and sealingly connected to the first mounting surface via the sealant; and
a second side wall, intersecting with the second mounting surface and facing away from the accommodating cavity, wherein the second side wall and the first side wall are disposed opposite to each other, and the first gap exists between the second side wall and the first side wall.

19. The core assembly according to claim 5, wherein in a direction in which the second side wall extends toward the lower housing, a size of the second side wall is greater than a size of the positioning portion.

20. The core assembly according to claim 9, wherein
a third gap exists between the second surface and the first side wall; and
the at least two intersecting paths further comprise the third gap, wherein the third gap is in communication with the first gap and the second gap, and the first gap and the third gap are located at two sides of the second gap.
